(19) United States
(12) Patent Application Publication
(10) Pub. No.: US 2006/0113513 A1
(43) Pub. Date: Jun. 1, 2006

(54) Fire retardant and a method for production thereof

(76) Inventor: Jens Birger Nilsson, Mile End (AU)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/523,715

(22) PCT Filed: Aug. 5, 2003
(86) PCT No.: PCT/AU03/00980

§ 371 Date: May 17, 2005

(30) Foreign Application Priority Data
Aug. 7, 2002 (AU) 2002950614

(51) Int. Cl. C09K 21/00

(52) U.S. Cl. 252/601

(57) ABSTRACT

A fire retardant composition and a method of producing thereof. The composition comprising water, a highly concentrated alkali, at least one of or a combination thereof, of anhydrous citric acid, citric acid, acetic acid or a related salt thereto. The composition also includes phosphate as well as an alkali metal salt or compound from at least one of lithium, sodium and/or potassium cation in combination with at least one of an acetate, bicarbonate, carbonate and/or hydroxide anion. The composition is then adjusted to a pH value around 6.5% to 7.5% by adjusting the amounts of highly concentrated alkali and/or the citric acid/acetic acid respectively.

### FIELD OF THE INVENTION

The present invention relates to a fire retardant composition and a method of producing thereof. More specifically, the invention is directed to a fire retardant composition having endothermic properties to absorb considerable amounts of heat in association with the initial stages of a fire, and a method of producing such a composition.

### BACKGROUND ART

Traditionally, the hazardous effects of fire have been combated by the use of water. However, water as a sole agent is often unsuitable or ineffecient for combating certain fires. Hence, to improve the efficiency of water as a combating agent against fire, various materials and chemicals have been added to water.

For example, a physical particle suspension systems, such as liquid clay suspensions or water soluble chemicals to create mixtures that include surfactants to aid wetting, dispersion or penetration, foaming agents such as low boiling point chemicals, or methods such as the incorporation of compressed gases to produce foams have all been used in combination with water to improve its combating effect against fire and the fire's hazardous effects.

Nonetheless, many of these materials and properties of the modified water composition suffer inherent disadvantages, as such compositions are characterised in being toxic, corrosive, and/or detriment to the environment.

For example, the phosphates of sodium, potassium or ammonium when incorporated with water to improve the water's ability to combat fire results in the water having a relatively low thermal decomposition temperature, and thus under certain conditions will produce toxic gases as well as leaving a sticky residue during use.

Further, halogens are also conventionally added to improve the efficiency of water as a fire combating agent, but these also present disadvantages in respect to the environment, as such halogens can produce toxic gases and incur damage to the earth's ozone layer.

Hence, these conventionally known fire retardant compositions containing the above chemicals, as well as conventional brominated or phosphate ester flame retardants, all potentially involve a serious risk to biological life and its associated genetic structure.

In the context of this invention fire retardant is used to denote a chemical product that can prevent the ignition of fire or its development by binding considerable quantities of heat energy. The fire retardant provides a surface protection that can be applied to material so as to protect such material against the incident of fire and the associated open flame. This protection of the material against the open flame by not becoming material to fuel the fire, thereby prevents the further spread of the open flames of the fire.

Hence, the problem still remains for a fire retardant composition to protect the surface of a material it is applied to and also to limit the spread of fire by restricting the ability of the open flame to travel over the protected surface, while still remaining inherently environmentally friendly, inexpensive to produce and potentially remove the serious risk of injury, if the composition comes in contact with human skin or is swallowed.

### OBJECTS OF THE INVENTION

It is an object of this invention to provide a fire retardant composition that is naturally fully biodegradable and is able to absorb considerable amounts of heat energy, for example that heat associated with the initial stages of a fire.

A further object of the present invention is to provide a method for the production of such a fire retardant composition.

A still further object of the present invention is to overcome, or at least substantially ameliorate some of the disadvantages and shortcomings of conventional fire retardant compositions and methods of producing thereof that have been previously made available, or alternatively, at least provide the public with an improved fire retardant composition and a method of producing thereof to those presently known.

### SUMMARY OF THE INVENTION

Accordingly, in one form of the invention there is provided a fire retardant composition comprising:
(a) water in an amount at least sufficient to dissolve the following (b) to (e) water soluble components up to an amount to be non corrosive,
(b) a highly concentrated alkali, selected from a group, consisting of at least one of, or a combination thereof, of sodium hydroxide, potassium hydroxide and/or lithium hydroxide,
(c) at least one of, or a combination thereof, of anhydrous citric acid, citric acid, acetic acid or a related salt thereto,
(d) a phosphate,
(e) an alkali metal salt or compound selective from at least one of, or in combination with lithium, sodium and/or potassium caton in combination with at least one of an acetate, bicarbonate, carbonate and/or hydroxide anion,
wherein said composition is adjusted to a pH value between 6.5 to 7.5 by an amount of (b) and/or (c) respectively.

An advantage of such a fire retardant composition is that it is able to absorb large quantities of heat energy and therefore can be applied as a surface protection to materials to prevent ignition, reignition, or spread of the fire.

A further advantage is that the composition includes ingredients that are commercially readily available and inexpensive.

A further advantage of such a composition is that the fire retardant comprising the water with chemicals (b) to (e) is environmentally friendly.

Advantageously, the major components of the composition will readily undergo biodegradation, as the composition is near neutral in terms of pH value and is an ionic water soluble solution of non toxic ingredients, there is no adverse skin effect, if contact with the user is made.

A still further advantage is that the components that make up the fire retardant composition do not contain any known toxic or casemogenic substances and hence such composition may be classified as “non hazardous” according to Work Safe Australia criteria.

A still further advantage of such a fire retardant composition is that as the composition is a near neutral pH it reduces or eliminates corrosion effect. By reducing or eliminating corrosion effects, the fire retardant composition may be applied in applications such as bushfire control or hose/pipe distribution systems such as a sprinkler network in a building.

The Community has considerable interest in controlling the incidence of uncontrolled spreading of fires. Presently such forest fires are controlled by the introduction of what are known as “fire breaks” in the forests and on the ground, and by spraying the foliage in these regions with a flame retardant. Nonetheless, as discussed above the problem with these conventionally known fire retardant compositions, is that they are inherently environmentally unfriendly, and therefore potentially may damage or kill material to which it is being applied to.

However, the fire retardant composition of the present invention by virtue of the components making up said composition, allows for the fire retardant to be placed onto plant foliage or the ground within the forest without adverse environmental effects. Since the environment is not in any way exposed to any toxic or harmful substances present in the fire retardant composition, there are no risks of future damage to the forest or the land by the application of the composition.

The flame retardant composition of this invention provides an improved alternative to the fire retardants that are currently used for active spreading through a sprinkler system when there is a risk of the incident of fire. Through the absence of environmental toxins and the extremely good energy absorbing ability of the fire retardant composition of this invention, there is provided a safe and practical composition that may be placed in environments that are characterise by, for example, “hot working” associated with welding or cutting processes. Advantageously, the same situation is true for equivalent environments for example storage locations which readily house and contain flammable products such as wood, paper and cellulose.

Coal dust in combination with methane gas constitutes a serious risk in the coal industry, and the flame retardant according to the invention should significantly reduce the risk for ignition of the coal dust and subsequent explosion.

A still further advantage of the fire retardant composition of the invention is that it may be used with readily flammable textiles without involving any disadvantages with respect to the colour or design of the textile.

In preference, the fire retardant composition highly concentrated alkali is at a concentration of greater than 80%.

In preference, the acetic acid is a concentrate and is at a concentration level of above 90%.

In preference, the fire retardant composition is characterised in that the phosphate is a tetra potassium pyro phosphate.

Preferably, the tetra potassium pyro phosphate is of a highly concentrated form of above 98% in order to avoid the formation of phosphate esters. The disadvantage of the creation of phosphate esters is due in part to the environmental risk these esters present to biological tissue.

In preference, the fire retardant composition further comprises anhydrous Dipotassium carbonate.

An advantage of having the dipotassium carbonate included in the fire retardant composition is that it constitutes an additional component for stabilising the composition.

In preference, the fire retardant composition further comprises a softening agent. Preferably a surfactant having the equivalent or the same effect as Ampholak YCE Berol.

An advantage of having the fire retardant composition including a softener is that in certain applications it improves the compositions ability to adhere to certain surfaces to be protected. For example, when the fire retardant composition is applied to textiles, the softener provides for efficient spreading of the composition into the depths of the fibres making up the textile.

In preference, the fire retardant composition has the composition adjusted for a resultant specific gravity in the range of 1.1 to 1.5. Preferably, the specific gravity of the composition is about 1.3.

In preference, the alkali metal salt or compound of the fire retardant composition is potassium acetate.

In preference, the fire retardant composition comprises the range of about 28% to 38% by weight of water.

In preference, the fire retardant composition comprises the range of 15-25% of the highly concentrated alkali. Preferably, the highly concentrated alkali is potassium hydroxide.

In preference, the fire retardant composition includes a combination of acetic acid and citric acid. Preferably, the composition comprises a range of about 8-13% by weight of the acetic acid. Further, the composition preferably comprises a range of about 17-24% by weight of the citric acid.

In preference, the fire retardant composition comprises a range of about 6-10% of dipotassium carbonate.

In preference, the phosphate included in the fire retardant composition is tetra potassium pyro phosphate. Preferably, the composition comprises a range of about 1.5 to 3% by weight of tetra potassium pyro phosphate.

In preference, the fire retardant composition comprises a range of about 3 to 5% sodium hydrogen carbonate. Preferably, if a softener is added to the composition for more efficient spreading of the retardant onto material it will be in the range of 0.5 to 1.5% by weight of said composition.

In a further form of the invention, there is a method for producing a fire retardant composition in that the following components are added in sequence to a vessel under stirring;
(a) water in an amount at least sufficient to dissolve the following (b) to (e) water soluble components up to an amount to be non corrosive,
(b) a highly concentrated alkali, selected from a group, consisting of at least one of, or a combination thereof, of sodium hydroxide, potassium hydroxide and/or lithium hydroxide,
(c) at least one of, or a combination thereof, of anhydrous citric acid, citric acid, acetic acid or a related salt thereto,
(d) a phosphate,
(e) an alkali metal salt or compound selective from at least one of, or in combination with lithium, sodium and/or potassium cation in combination with at least one of an acetate, bicarbonate, carbonate and/or hydroxide anion,

whereby the added components are adapted such that the final product has a pH value within the range of 6.5 to 7.5 and a density within the range of 1.2 to 1.4.

In a further form of the invention there is provided a method for producing a fire retardant composition characterized in that the following components are added in sequence to the vessel under stirring:

(c) water;

(d) potassium hydroxide;

(e) acidic acid;

(f) citric acid;

(g) dipotassium carbonate;

(h) tetra potassium pyro phosphate

(i) sodium hydrogen carbonate;

(j) softener

whereby, the added components are adapted such that the final product has a pH value within the interval of 6.5 to 7.5 and a density within the range of 1.2 to 1.4.

In preference, the method of producing the fire retardant composition is further characterised in that the components added under stirring are simultaneously influenced by an energy wave, generated mechanically, during the simultaneous influence of a variable magnetic field, applied externally.

### DETAILED DESCRIPTION OF THE INVENTION

To further illustrate this invention, a series of fire retardant compositions were prepared with naturally fully degradable organic acids and non organic alkali's that are mixed during stirring in a vessel, giving rise to chemical reactions, together with the addition of substances that stabilize the chemical reactions, such that the salt formed and the overall characteristics of the fire retardant composition have an endo thermic property.

The design to produce a final product with an optimal endo thermic property leads to the production process comprising exothermic reactions. Thus, large quantities of heat are developed during the mixing procedure. The use of the flame retardant compositions that contain only naturally occurring raw materials, with this no known risk to biological health, increases the opportunity for general use of the flame retardant composition produced by the methods described below.

Nonetheless, the following examples are for illustrative purposes only, and is recognised that minor changes and/or alterations might be made that are not immediately disclose herein. It is to be understood that to the extent that any such changes do not materially alter the final product or its functionality, such changes are considered as falling within the spirit and scope of the invention as defined by the claims that follow.

### EXPERIMENTAL PROCEDURES

### Example 1

The components that are included in the flame retardant composition together form an organic salt with a weakly basic pH in the region of 6.5 to 7.5, preferably 7.1 and a density within the region of 1.2 to 1.4, preferably 1.3. Such limits make it possible to apply the composition using simple known methods within most areas of possible application.

Example 1 is based on the mixing of non organic solutions with organic acids with a strong development of chemical heat (an exothermic reaction). By the addition of a fluid (such as water in Examples 1, 2) to a vessel that allows stirring in one plane of rotation (x,y) and by maintaining the stirring of the water such that the fluid itself rotates, advantageous conditions are created for an efficient mixing of the substances that are included in the composition and that involve an exothermic reaction.

The components listed below by weight will be added to the water component which has been placed in a high speed mixing vessel. Those values listed are a percentage by weight of the total fire retardant composition:

Water 33%

Potassium Hydroxide 21%

Acidic Acid 10%

Citric Acid 21%

Potash 8%

Tetra Potassium Pyro Phosphate 2%

Sodium Hydrogen Carbonate 4%

Softener 1%

The water component is placed in a mixing vessel and the other components added in the sequence listed below.

To the water is added a stream directed in towards to the centre of rotation of the water, of a highly concentrated (more than 87%) potassium hydroxide. With the addition of the highly concentrated alkali such as in the example, potassium hydroxide, a chemical reaction and the associated exothermic reaction will be achieved with this type of mixing.

This relevant mixture is rotated and a directed stream of a highly concentrated acidic acid (above 96%) is added during vigorous stirring, whereby an exothermic reaction again arises.

A naturally occurring citric acid, completely free of water, is then added to the mixture which remains under continued rotation.

Dipotassium carbonate also known as potash and completely free of water, is then added during continued rotation. The carbonate constitutes an important component for stabilizing the mixture.

Phosphate is then added in a very low fraction as indicated above at about 2%. The phosphate is primarily chosen in the form of tetra potassium pyrophosphate and in a highly concentrated form (above 99.5%) in order to avoid the addition of phosphate esters. This is mainly due to the environmental risk of using phosphate esters. The tetra potassium pyrophosphate is added during vigorous stirring.

Sodium hydrogen carbonate is added after the addition of the phosphate in order to create a further stable mixture. It should be noted that 10% of the chemical raw materials are released in the form of carbon dioxide during the chemical processes.

In this example a softener is added to the composition,

The pH of the final product, for example 7.1, is adjusted to the desired value by the addition of potassium hydroxide or acetic acid.

The fire retardant composition is finally checked with respect to its density. The density should be approximately 1.3.

It has proved to be practically applicable that components added during stirring are simultaneously influenced by an energy wave, generated mechanically, during the simultaneous influence of a variable magnetic field, applied externally.

### Example 2

In this example of a further illustrated form of the invention a fire retardant composition of a di-alkali-metal citrate salt in which the alkali-metal cation is selected from the Group 1 A alkali-metals lithium, sodium and potassium and having a resultant pH value in the range of 6.5 to 7.5, by the addition of one or more Group 1A alkali-metal basic salts or compounds selected from the cations lithium, sodium and potassium, and the anions acetate, bicarbonate, carbonate and hydroxide.

The preferred citrate salt is di-potassium citrate and the preferred basic salt is potassium acetate. The retardant salt or salt mixture may optionally include a small amount of tetra potassium pyro-phosphate, which is generally considered to be the least potentially harmful of the phosphate family, to improve performance stability and endothermic capacity at higher temperatures.

The retardant may optionally include additional neutralising or buffering compounds such as, for example, sodium bicarbonate and/or potassium carbonate.

The retardant has a pH value in the range of 6.5 to 7.5 and a specific gravity value in the range of 1.2 to 1.4, and a typical analysis (approximate values) of the retardant when made as indicated in Example 2 is pH=7.15, SG=1.365.

| | |
|---|---|
| Citrate salt | 10% |
| Acetate salt | 28% |
| Phosphate salt | 2% |
| Sodium Bicarbonate | 3% |
| Water | 47% |

It should be noted that unless otherwise indicated, all percentages are percentages by weight referred to molecular weights, and all pH values and specific gravity values are in reference to measurements at 20° C. It should also be noted that the high salt concentrations will incur the “salt-effect” in respect of pH measurements. Solubility data should be consulted and taken into account for formulations in accordance with this example.

The retardant may be manufactured from the raw material ingredient citric acid by controlled reaction with a basic salt or compound selected from the Group 1A alkali-metal cations of lithium, sodium and potassium, an the anions acetate, bicarbonate, carbonate and hydroxide, to produce di-alkali-metal citrate.

Citric acid has a molecular weight of 192.070, a solubility of 622 gm/1 (approx 3 gmw citric acid/55 gmw H₂O), and a pH in solution in water of between about 1.3 to about 2.0. It exhibits a temperature depression on solution (endothermic). Reaction of citric acid with basic substances generates considerable heat energy which is accompanied by frothing or foaming and care must be exercised to control the rate of reactant addition to keep the temperature down and avoid excessive foaming. In addition, the use of stainless steel mixing vessels and efficient mixing techniques will aid in heat dissipation and foam dispersion as well as increasing the efficiency of reaction.

The following steps illustrate various aspects of the reactions involved in the second example, and of a method of manufacturing.

Step 1
C₆H₈O₇+2KOH+18 H₂O=K₂C₆H₆O₇+20H₂O+Heat
192.070+112.216+324.288=268.254+360.320=628.574
42.7%+57.5%=100%

Solution of 1 gmw of citric acid in 18 gmw of water gave a pH of about 2.0.

Controlled addition of 2 gmw of potassium hydroxide and keeping the temperature under 50° C. results in the formation of mono-potassium citrate up to about pH 3.5 and then di-potassium citrate from about pH 3.5, up to about pH 5.2.

A similar reaction comprising 9C₆H₈O₇+18KOH+50 H₂O resulted in a pH of about 5.6

Step 2

In a similar manner to step 1 but using lithium carbonate as the basic reactant with citric acid, namely,
C₆H₈O₇+Li₂C O₃+18 H₂O=Li₂H₆O₇+19 H₂O+CO₂
192.070+73.891+324.288=203.934+342,304+44.011=590.249
34.6%+58.0%+7.4%=100%

As the solubility of lithium carbonate is very low at 1.3 gm/l (1 gmw Li₂CO₃/313 gmw H₂O), the citric acid is added to the water and then the lithium carbonate added as reactant. Less heat is generated in this reaction but the CO₂ evolution causes a considerable volume expansion as foam which must be mitigated with efficient mixing or stirring. As CO₂ is a “greenhouse” gas it should be collected for other use and prevented from entering the atmosphere. The pH of the resultant di-lithium citrate is about 4.5.

Step 3

In a similar manner,
2CH₃COOH+Li₂CO₃+8H₂O=2 CH₃COOLi+9H₂O+CO₂
resulting at pH about 5.8.

Step 4

To 10 gmw of H₂O is added 2 gmw of KOH slowly to control the heat of solution and keep the temperature below about 50° C. Then 1 gmw of acetic acid is slowly added to produce 1 gmw of potassium acetate CH₃COOK, at a pH of about 9.5.
CH₃COOH+KOH+10 H₂O=CH₃COOK+11 H₂O+HEAT
60.054+56.108+180.160=98.146+198.176=296.322
33.1%+66.5%=100%

Step 5

In a similar manner to step 4,
18 CH₃COOH+18 KOH+50 H₂O=18 CH₃COOK+68 H₂O+HEAT
1080.972+1009.944+900.800=1766.628+1255.088=2991.716
59.1%+40.9%=100%

This step reflects the minimum solubility requirement of KOH

Step 6

Solid CH₃COOK is dissolved in water which results in an alkaline solution having a pH of from about 8.7, up to about 11.1 at the limit of solubility which is 2530 gm/l or 25 CH₃COOK/55 H₂O. 18 CH₃COOK is added to 68 H²O and dissolved. 18 KOH dissolved in 130 H₂O is then added followed by slow addition of solid citric acid. The reaction may be summarised
18 CH₃COOK+9 K₂C₆H₆O₇+216 H_{2l O}
1766.628+2414.286+3891.456=8072.370
21.9%+29.9%+48.2%=100%

Step 7

The ingredients are mixed in the following order:

| | |
|---|---|
| Water (pH 6.5) | 33% |
| KOH (minimum 85% lye) | 21% |
| CH₃COOH (minimum 96%) | 10% |
| Citric acid C₆H₈O₇ anhydrous | 21% |

At this stage the pH was measured at about 5.8, and SG=1.310

| | |
|---|---|
| K₂CO₃ anhydrous | 8% |
| K₄P₂O₇ (minimum 99.5%) | 2% |
| NaHCO₃ (minimum 99.5%) | 4% |
| Surfactant - Ampholak YCE Berol | 1% |

The pH is adjusted to the preferred value using additional amounts of KOH K₂C O₃, or NaHCO₃, or can also be adjusted by additional amounts of CH₃COOK, or acetic or citric acids as required.

The reactions of this example may be summarised as:

$$180 {H}_{2} O + 18 K O H + 18 C {H}_{3} C O O H = 18 C {H}_{3} C O O K + 198 {H}_{2} O$$

$$18 C {H}_{3} C O O K + 198 {H}_{2} O + 18 K O H + 9 {C}_{6} {H}_{8} {O}_{7} = 18 C {H}_{3} C O O K + 9 {K}_{2} {C}_{6} {H}_{8} {O}_{7} + 216 {H}_{2} O = 22 \% + 30 \% + 48 \%$$

and on accounting for the additional ingredients will approximate to the typical analysis results described above.

The retardant when stored in an internal protected environment in a sealed container at room temperature has a shelf life in excess of 2 years. On exposure to external unprotected Australian Autumn/Winter conditions it will biodegrade in less then 3 months.

Measurements of temperature, pH and specific gravity in respect of the foregoing examples indicate that the pH of the retardant product can be readily adjusted or buffered to a value from about 4.5 to 6.5, and advantage can be taken of this pH range to generate a near-neutral foam using the known “soda” or “soda-acid” principle using appropriate ratios of the retardant to alkali-metal salt or compound of which sodium bicarbonate or potassium carbonate are preferred. Experiments were conducted which showed that a considerable amount of foam can be generated and pH measurements of the resultant foam showed that the pH was near-neutral, within the range of 6.5 to 7.5.

The retardant of this invention is also ideal for combination with other expansion agents such as the protein-based agents or some of the fluoroiodocarbons (FICS) which are said to be non-toxic and environmentally safe. Compressed air foam systems (CAFS) using the retardant of this invention in concentrate for, i.e. formulated for minimum water content which in practical terms is about 60-75% by weight, may be particularly advantageous as a common mix ratio is 0.2% concentrate by volume producing a foam (average expansion=10) of 0.2% concentrate, 9.98% water and 98% air.

Thus the fire retardant compositions produced by the methods according to the invention are based upon chemical reactions between organic adds that are fully naturally degradable and non organic alkali's, with a certain addition of substances to stabilize the reaction, with the aim of forming a salt with good endo thermic properties, suitable for the purpose of obtaining a non toxic, water soluble fire retardant that is naturally degradable.

Although the invention has been described in terms of specific embodiments which are set forth in considerable detail by way of examples 1 and 2, it should be understood that this description is by way of illustration only, and that the invention is not necessarily limited thereto since alternative embodiments and preparation techniques will become apparent to those skilled in the art in view of the disclosure.

Accordingly, modifications are contemplated which could be made without departing once again as indicated from above to the spirit and scope of the described invention.

1. A fire retardant composition comprising:
(a) water in an amount at least sufficient to dissolve the following (b) to (e) water soluble components up to an amount to be non corrosive,
(b) a highly concentrated alkali, selected from a group, consisting of at least one of, or a combination thereof, of sodium hydroxide, potassium hydroxide and/or lithium hydroxide,
(c) at least one of, or a combination thereof, of anhydrous citric acid, citric acid, acetic acid or a related salt thereto,
(d) a phosphate,
(e) an alkali metal salt or compound selective from at least one of, or in combination with lithium, sodium and/or potassium cation in combination with at least one of an acetate, bicarbonate, carbonate and/or hydroxide anion,
wherein said composition is adjusted to a pH value between 6.5 to 7.5 by an amount of (b) and/or (c) respectively.

2. The composition of claim 1, wherein the concentrate of the acetic acid is above 90%.

3. The composition of claim 1, wherein the highly concentrated alkali is at a concentration of greater than 80%.

4. The composition of claim 3 wherein the highly concentrated alkali is potassium hydroxide.

5. The composition of claim 1, wherein the phosphate is tetra potassium pyro phosphate.

6. The composition of claim 5 further comprising an anhydrous dipotassium carbonate.

7. The composition of claim 6 further comprising a softening agent.

8. The composition of claim 7 wherein the composition is adjusted for a resultant specific gravity in the range of 1.1 to 1.4.

9. The composition of claim 8 wherein the composition has a specific gravity of about 1.3.

10. The composition of claim 1, wherein the alkali metal salt or compound is potassium acetate.

11. The composition of claim 7 comprising the range of about 28% to 38% by weight of said water.

12. The composition of claim 11 comprising the range of 15% to 25% by weight of the highly concentrated alkali.

13. The composition of claim 12 wherein said highly concentrated alkali is potassium hydroxide.

14. The composition of claim 13 wherein said component (c) is a combination of citric acid and acetic acid.

15. The composition of claim 14 comprising in the range of about 8% to 13% by weight of said acidic acid.

16. The composition of claim 13 comprising in the range of about 17% to 24% by weight of said acetic acid.

17. The composition of claim 16, comprising in the range of about 6% to 10% by weight of dipotassium carbonate.

18. The composition of claim 17, comprising in the range of about 2% to 3% by weight of tetra potassium pyrophosphate.

19. The composition of claim 18 comprising in the range of about 3% to 5% sodium hydrogen carbonate.

20. The composition according to claim 19 comprising in the range of about .5% to 1.5% softening agent.

21. A method for the production for flame retardant composition wherein the following components are added in sequence to a vessel under stirring;
(a) water in an amount at least sufficient to dissolve the following (b) to (e) water soluble components up to an amount to be non corrosive,
(b) a highly concentrated alkali, selected from a group, consisting of at least one of, or a combination thereof, of sodium hydroxide, potassium hydroxide and/or lithium hydroxide,
(c) at least one of, or a combination thereof, of anhydrous citric acid, citric acid, acetic acid or a related salt thereto,
(d) a phosphate,
(e) an alkali metal salt or compound selective from at least one of, or in combination with lithium, sodium and/or potassium cation in combination with at least one of an acetate, bicarbonate, carbonate and/or hydroxide anion,
whereby the added components are adapted such that the final product has a pH value within the range of 6.5 to 7.5 and a density within the range of 1.2 to 1.4.

22. A method for the production for flame retardant composition wherein a method for producing a fire retardant composition characterized in that the following components are added in sequence to the vessel under stirring:
(k) water;
(I) potassium hydroxide;
(m) acidic acid;
(n) citric acid;
(o) dipotassium carbonate;
(p) tetra potassium pyro phosphate
(q) sodium hydrogen carbonate;
(r) softener
whereby, the added components are adapted such that the final product has a pH value within the interval of 6.5 to 7.5 and a density within the range of 1.2 to 1.4.

23. The method according to claim 22, characterised in that the components added under stirring are simultaneously influenced by an energy wave, generated mechanically, during the simultaneous influence of a variable magnetic field, applied externally.

24. The fire retardant composition of claim 1 further comprising an expansion agent, propellant or compressed gas to produce a fire retardant foam.

25-26. (canceled)

27. The method according to claim 21, characterised in that the components added under stirring are simultaneously influenced by an energy wave, generated mechanically, during the simultaneous influence of a variable magnetic field, applied externally.
